(19) United States
(12) Patent Application Publication
(10) Pub. No.: US 2026/0252677 A1
(43) Pub. Date: Aug. 27, 2026

(54) SYSTEMS AND METHODS FOR MANAGING TOOL ACCESS CONTROL AT AN AGENTIC ARTIFICIAL INTELLIGENCE SERVER

(71) Applicant: Kore.ai, Inc., Orlando, FL (US)

(72) Inventors: Rajkumar KONERU, Windermere, FL (US); Prasanna Kumar Arikala Gunalan, Hyderabad (IN); Girish Ahankari, Hyderabad (IN)

(21) Appl. No.: 19/061,839

(22) Filed: Feb. 24, 2025

(51) Int. Cl. G06F 21/44; G06F 21/60

(52) U.S. Cl. CPC G06F 21/44; G06F 21/604

(57) ABSTRACT

A method implemented by an agentic artificial intelligence platform (agentic AI platform) comprises receiving one or more requests to access one or more tools from one or more AI agents. The one or more requests are analyzed to determine whether the one or more AI agents need an approval to access the one or more tools, based on a context of a corresponding one of the requests and one or more business rules. The one or more requests are provided to an approver when the determination indicates the one or more AI agents need the approval to access a corresponding one or more of the tools. Subsequently, the access to the corresponding one or more tools by the one or more AI agents is allowed upon receiving the approval from the approver.

### FIELD

This technology generally relates to artificial intelligence agents (AI agents), and more particularly to methods, systems, and computer-readable media for managing and controlling access to tools by AI agents in an agentic artificial intelligence (agentic AI) system.

### BACKGROUND

In recent years, with the advancements in large language models (LLMs) and artificial intelligence (AI) technologies, enterprises are focusing on transitioning from narrow task-specific dialog flow based applications to versatile agentic artificial intelligence (agentic AI) applications constituting AI agents fueled by LLMs. AI agents may be referred to as advanced AI based applications comprising capabilities to independently engage in meaningful conversations, analyze complex instructions, make decisions, access tools and services, and execute actions based on the specified goals and objectives with minimal human intervention. Due to their potential and autonomous capabilities, AI agents are increasingly being deployed by enterprises across industries and domains.

However, AI agents often require access to critical and sensitive tools, services, or data repositories to complete tasks effectively, which may pose significant challenges related to safety, security, and compliance. For example, an AI agent configured to manage bank financial transactions may require access to core banking and payment gateway systems, while another AI agent configured for customer service may require access to customer relationship management (CRM) platforms, which are critical resources comprising sensitive enterprise or customer data. Without robust mechanisms to control and monitor these sensitive data interactions performed by AI agents, there exists a potential risk of unforeseen and unintended actions from AI agents or exploitation of AI agents for misuse by malicious attackers.

Existing methods for controlling access to tools by AI agents are designed based on predefined rules which are not suitable for all contexts or scenarios and need to be periodically reviewed and updated. As AI agents operate dynamically and may request access to tools or services in real-time based on evolving tasks or contextual needs, the existing tool access control methods are often insufficient for AI agents. Additionally, AI agents may request access to tools or services that exceed the original scope of AI agents deployment or are inconsistent with organizational policies or regulations, necessitating real-time validation and governance of the tool access requests.

Hence, there is a need for systems and methods to provide fine-grained control over AI agents accessing tools and services, ensuring AI agents operate securely, transparently, and within predefined constraints.

### SUMMARY

In an example, the present disclosure relates to a method for controlling access to one or more tools by one or more AI agents. The method performed by an agentic artificial intelligence platform (agentic AI platform) comprises receiving one or more requests to access one or more tools from one or more AI agents. The agentic AI platform then analyzes the one or more requests to determine when the one or more AI agents need an approval to access the one or more tools, based on a context of a corresponding one of the requests and one or more business rules. Further, the agentic AI platform provides the one or more requests to an approver when the determination indicates the one or more AI agents need the approval to access a corresponding one or more of the tools. Subsequently, the agentic AI platform allows the access to the corresponding one or more of the tools by the one or more AI agents upon receiving the approval from the approver.

In another example, the present disclosure relates to an agentic artificial intelligence server (agentic AI server) comprising one or more processors and a memory. The memory coupled to the one or more processors which are configured to execute programmed instructions stored in the memory to receive one or more requests to access one or more tools from one or more AI agents. The one or more requests are then analyzed to determine when the one or more AI agents need an approval to access the one or more tools, based on a context of a corresponding one of the requests and one or more business rules. Further, the one or more requests are provided to an approver when the determination indicates the one or more AI agents need the approval to access a corresponding one or more of the tools. Subsequently, the access to the corresponding one or more of the tools by the one or more AI agents is allowed upon receiving the approval from the approver.

In another example, the present disclosure relates to a non-transitory computer readable storage medium storing instructions which when executed by one or more processors, causes the one or more processors to receive one or more requests to access one or more tools from one or more AI agents. The one or more requests are then analyzed to determine when the one or more AI agents need an approval to access the one or more tools, based on a context of a corresponding one of the requests and one or more business rules. Further, the one or more requests are provided to an approver when the determination indicates the one or more AI agents need the approval to access a corresponding one or more of the tools. Subsequently, the access to the corresponding one or more of the tools by the one or more AI agents is allowed upon receiving the approval from the approver.

In another example, the present disclosure relates to a method for controlling access to one or more tools by one or more AI agents. The method performed by an agentic AI platform comprises receiving a request to access a first tool from a first AI agent of a plurality of AI agents. The agentic AI platform then determines that the first AI agent is not authorized to access the first tool based on a context of the request and one or more business rules. The agentic AI platform identifies one or more second AI agents of the plurality of AI agents that are authorized to access the first tool. Further, the agentic AI platform prompts one of the second AI agents to access the first tool based on the context of the request. Subsequently, the agentic AI platform provides to the first AI agent, a result of accessing the first tool received from the prompted second AI agent.

### BRIEF DESCRIPTION OF THE DRAWINGS

FIG. 1A is a block diagram of an exemplary environment with an agentic artificial intelligence server (agentic AI server) configured to manage and orchestrate conversations using AI agents.

FIG. 1B is a block diagram of the agentic AI platform of the agentic AI server illustrated in FIG. 1A.

FIGS. 2A-2G are wireframes of graphical user interface screens of an agentic application builder illustrating exemplary ways to develop, configure, deploy, and simulate agentic applications and AI agents on the agentic AI server illustrated in FIG. 1A.

FIG. 2H is a wireframe of an exemplary graphical user interface screen of a tool permissions manager illustrated in FIG. 1B.

FIG. 3A is a flowchart of an exemplary method for managing and controlling access to tools by AI agents at the agentic AI server illustrated in FIG. 1A.

FIG. 3B is a flowchart of another exemplary method for managing and controlling access to tools by AI agents at the agentic AI server illustrated in FIG. 1A.

FIG. 4A is an exemplary flow diagram of method illustrated in FIG. 3A for managing and controlling access to tools by AI agents at the agentic AI server shown in FIG. 1A.

FIG. 4B is an exemplary flow diagram of method illustrated in FIG. 3B for managing and controlling access to tools by AI agents at the agentic AI server shown in FIG. 1A.

### DESCRIPTION

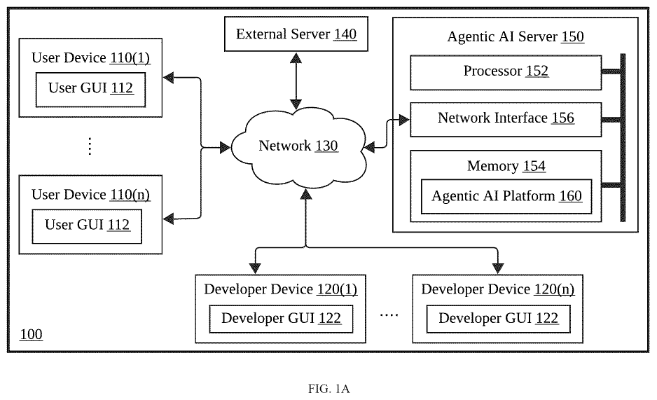

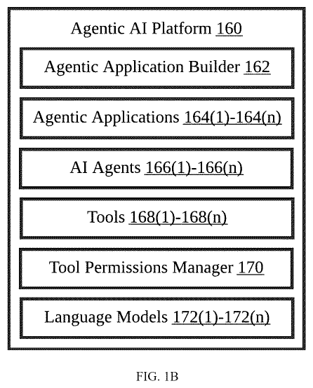

Examples of the present disclosure relate to an agentic AI server environment 100 (illustrated in FIG. 1A) and, more particularly, to one or more components, systems, computer-readable media, and methods for managing and controlling access to tools and services by AI agents in an agentic AI system. The agentic AI server environment 100 enables enterprise users (e.g., developers, system administrators, business analysts, solution engineers) operating developer devices to, by way of example, design, develop, deploy, manage, host, and analyze AI agents. Further, the agentic AI server environment 100 enables the enterprise users to, by way of example, design, develop and configure the AI agents to communicate with language models for responding to user inputs.

FIG. 1A is a block diagram of an exemplary agentic AI server environment 100 for implementing the concepts and technologies disclosed herein. The agentic AI server environment 100 includes one or more user devices 110(1)-110(n), one or more developer devices 120(1)-120(n), an external server 140, and an agentic artificial intelligence server 150 (agentic AI server 150) all coupled together via a network 130, although the agentic AI server environment 100 can include other types and numbers of systems, devices, components, and/or elements in other topologies and deployments in other examples. Although not illustrated, the agentic AI server environment 100 may include additional network components, such as routers, switches, and other devices, which are well known to those of ordinary skill in the art and thus will not be described here.

The one or more user devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more user devices 110(1)-110(n) may have other types and/or numbers of other systems, devices, components, and/or elements in other examples. The users accessing the one or more user devices 110(1)-110(n) provide inputs (e.g., in text, voice, or a combination thereof) to the agentic AI server 150. The agentic AI server 150 provides responses to the inputs via the agentic AI platform 160 using one or more AI agents. In one example, the agentic AI server 150 communicates with the external server 140 to provide responses to the inputs.

The one or more enterprise users, for example, developers may access and interact with the functionalities exposed by the agentic AI server 150 and the external server 140 via the network 130 using the one or more developer devices 120(1)-120(n). The one or more developer devices 120(1)-120(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 120(1)-120(n) may include software and hardware capable of communicating with the agentic AI server 150 and/or the external server 140 via the network 130. Also, the one or more developer devices 120(1)-120(n) may comprise a developer graphical user interface (GUI) 122 to render and display the information received from the agentic AI server 150 and the external server 140. The one or more developer devices 120(1)-120(n) may communicate with the agentic AI server 150 and/or the external server 140 via one or more application programming interfaces (APIs) or one or more hyperlinks exposed by the agentic AI server 150 and/or the external server 140 respectively, although other types and/or numbers of communication methods may be used in other examples.

The one or more developer devices 120(1)-120(n) may run applications, such as web browsers or AI agent software, which may render the developer GUI 122, although other types and/or numbers of applications may render the developer GUI 122 in other example configurations.

In one example, the one or more developers at the one or more developer devices 120(1)-120(n) may, by way of example, make selections, provide inputs using the developer GUI 122 or interact, by way of example, with data, icons, widgets, or other components displayed in the developer GUI 122.

The network 130 enables the one or more user devices 110(1)-110(n), the one or more developer devices 120(1)-120(n), the external server 140, or other such devices to communicate with the agentic AI server 150. The network 130 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, a worldwide interoperability for microwave access (WiMAX) network, or a combination of two or more such networks, although the network 130 may include other types and/or numbers of networks in other topologies or configurations.

The network 130 may support protocols such as, Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Description Protocol (SDP), Web Real-Time Communication (WebRTC), Transmission Control Protocol/Internet Protocol (TCP/IP), User Datagram Protocol (UDP), or Voice over Internet Protocol (VoIP), although other types and/or numbers of protocols may be supported in other topologies or configurations. The network 130 may also support standards or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. The network interface 156 of the agentic AI server 150 may include any interface that is suitable to connect with any of the above-mentioned network types and communicate using any of the above-mentioned network protocols, standards, or formats.

The agentic AI server 150 includes a processor 152, a memory 154 and a network interface 156, although the agentic AI server 150 may include other types and/or numbers of components in other examples. In addition, the agentic AI server 150 may include an operating system (not shown). In one example, the agentic AI server 150, one or more components of the agentic AI server 150, and/or one or more processes performed by the agentic AI server 150 may be implemented using a networking environment (e.g., cloud computing environment). In one example, the capabilities of the agentic AI server 150 may be offered as a service, such as, for example, software-as-a-service (SaaS) using the cloud computing environment.

The components of the agentic AI server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, an Small Computer Systems Interface (SCSI) bus, or a combination of two or more of these, although other types and/or numbers of buses may be used in other examples.

The processor 152 of the agentic AI server 150 may execute one or more computer-executable instructions stored in the memory 154 for the methods illustrated and described with reference to the examples herein, although the processor 152 may execute other types and numbers of instructions and perform other types and numbers of operations in other examples. The processor 152 may comprise one or more central processing units (CPUs) with one or more processing cores and a cache memory for local storage of data and instructions, although the processor 152 may comprise other types and/or numbers of components in other examples. In one example, the functions of the processor 152 may be spread across one or more linked or networked devices or modules. Although the agentic AI server 150 may comprise multiple processors, only a single processor (i.e., the processor 152) is illustrated in FIG. 1A for simplicity.

The memory 154 of the agentic AI server 150 is an example of a non-transitory computer readable storage medium capable of storing information or instructions for the processor 152 to operate on. The instructions, which when executed by the processor 152, perform one or more of the disclosed examples. In one example, the memory 154 may be a random access memory (RAM), a dynamic random access memory (DRAM), a static random access memory (SRAM), a persistent memory (PMEM), a non-volatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, or a combination of two or more of these. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1A, the memory 154 may include instructions corresponding to an agentic AI platform 160 of the agentic AI server 150, although other types and/or numbers of instructions in the form of programs, functions, methods, procedures, definitions, subroutines, or modules may be stored in other examples. The memory 154 may also include data structures storing information corresponding to the agentic AI platform 160. The agentic AI server 150 receives communications from one or more users at the one or more user devices 110(1)-110(n) and/or one or more developers at the one or more developer devices 120(1)-120(n) and uses the agentic AI platform 160 to provide responses to the received communications and/or perform necessary actions based on the received communications.

The network interface 156 may include hardware, software, or a combination of hardware and software, enabling the agentic AI server 150 to communicate with the components illustrated in the agentic AI server environment 100, although the network interface 156 may enable communications with other types and/or number of components in other examples. In one example, the network interface 156 provides interfaces between the agentic AI server 150 and the network 130. The network interface 156 may support wired or wireless communications. In one example, the network interface 156 may include an Ethernet adapter or a wireless network adapter to communicate with the network 130.

The users at the one or more user devices 110(1)-110(n) may access and interact with the functionalities exposed by the agentic AI server 150 via the network 130. The one or more user devices 110(1)-110(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more user devices 110(1)-110(n) may include software and hardware capable of communicating with the agentic AI server 150 via the network 130. Also, the one or more user devices 110(1)-110(n) may render and display the information received from the agentic AI server 150.

The users at the one or more user devices 110(1)-110(n) may interact with the agentic AI server 150 via the network 130 by providing inputs in text, voice, or a combination of text and voice via one or more communication channels (not shown in FIG. 1A). The one or more communication channels may include channels such as, enterprise messengers (e.g., Skype for Business, Microsoft Teams, Kore. ai Messenger, Slack, Google Hangouts, or the like), social messengers (e.g., Facebook Messenger, WhatsApp Business Messaging, Twitter, Lines, Telegram, or the like), web & mobile channels (e.g., a web application, a mobile application), interactive voice response (IVR) channels, voice channels (e.g., Google Assistant, Amazon Alexa, or the like), live chat channels (e.g., LivePerson, LiveChat, Zendesk Chat, Zoho Desk, or the like), a webhook channel, a short messaging service (SMS), email, a software-as-a-service (SaaS) application, voice over internet protocol (VoIP) calls, computer telephony calls, or the like. Although not illustrated in FIG. 1A, it may be understood that to support voice-based communication channels, the agentic AI environment 100 may also include, for example, a public switched telephone network (PSTN), a voice server, a text-to-speech (TTS) engine, and/or an automatic speech recognition (ASR) engine.

FIG. 1B is a block diagram of the agentic AI platform 160 of the agentic AI server 150 illustrated in FIG. 1A. As illustrated in FIG. 1B, the agentic AI platform 160 comprises instructions or data corresponding to an agentic application builder 162, one or more agentic applications 164(1)-164(n), one or more AI agents 166(1)-166(n), one or more tools 168(1)-168(n), a tool permissions manager 170, and one or more language models 172(1)-172(n), although other types and/or numbers of modules/components may be stored on the agentic AI platform 160 in other examples. The agentic AI platform 160 may store, manage, or otherwise provide data for delivering software services to the developers at the developer devices 120(1)-120(n) or the users at the user devices 110(1)-110(n). This data may be stored in one or more databases or tables as executable instructions in the form of programs, functions, subroutines, structured or unstructured text, or the like. Examples of the steps or functions performed when the programmed instructions stored in the memory 154 are executed are illustrated and described by way of the figures and description associated with the examples herein.

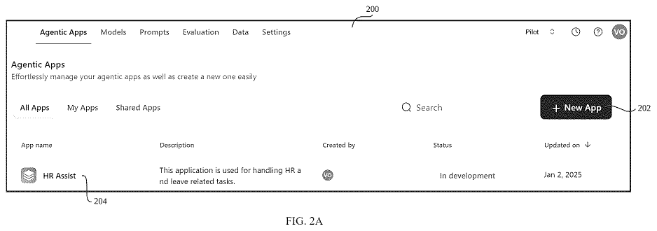

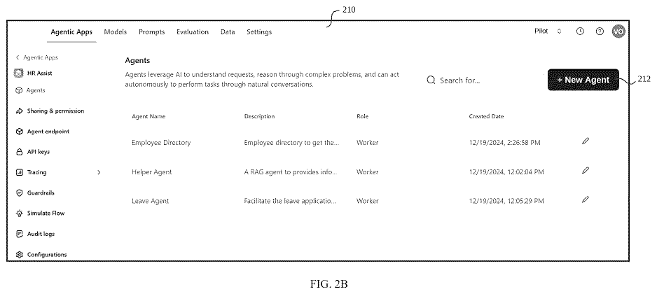

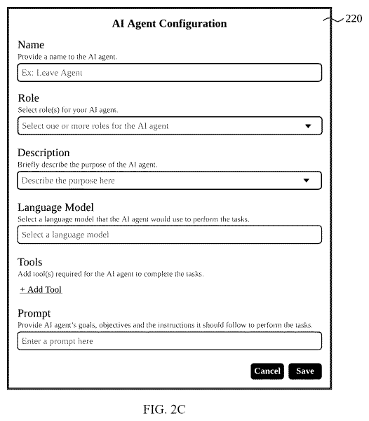

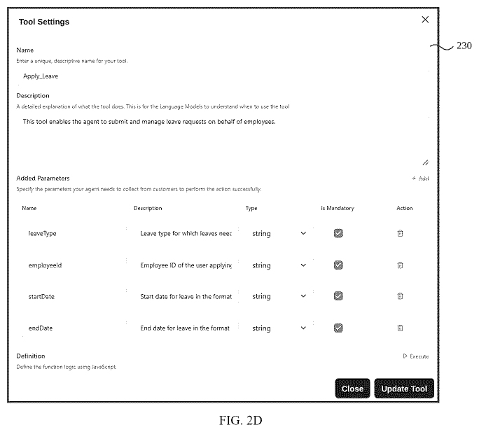

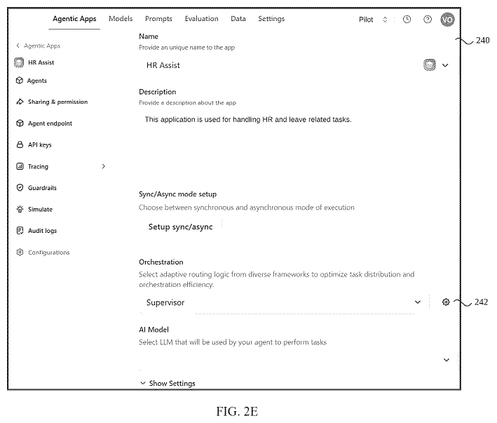

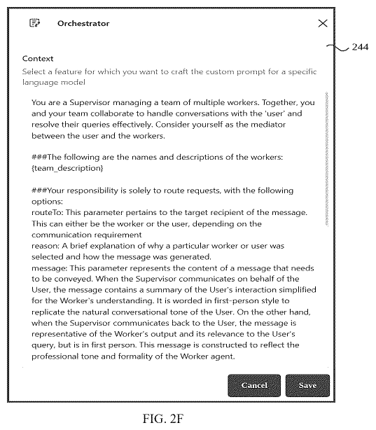

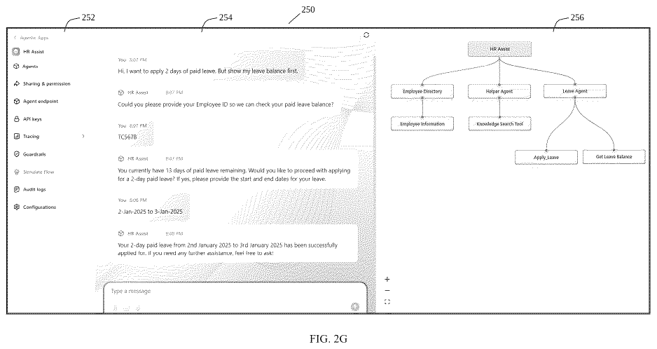

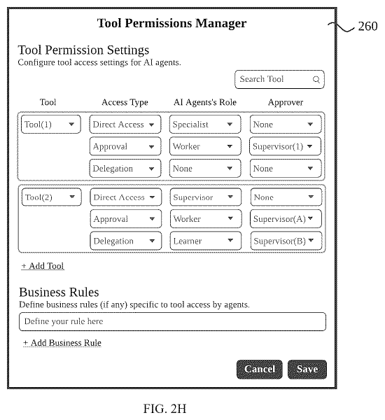

The agentic application builder 162 of the agentic AI platform 160 may be served from and/or hosted on the agentic AI server 150 and may be accessible as a website, a web application, or a software-as-a-service (SaaS) application, although the agentic application builder 162 may be accessible in other types and/or numbers of ways in other examples. Enterprise users, such as developers, solution engineers, market analysts, or business analysts, by way of example, may access the functionalities of the agentic application builder 162, for example, using web requests, API requests, although the functionalities of the agentic application builder 162 may be accessed using other types and/or numbers of methods in other examples. The one or more developers at the one or more developer devices 120(1)-120(n) may design, develop, configure, simulate and/or deploy: the one or more agentic applications 164(1)-164(n), the one or more AI agents 166(1)-166(n), and the one or more tools 168(1)-168(n) via the developer GUI 122 of the agentic application builder 162 (as illustrated in FIGS. 2A-2G). Additionally, the one or more developers at the one or more developer devices 120(1)-120(n) may host, create, import, configure, train, deploy, fine-tune, or optimize the one or more language models 172(1)-172(n) via the agentic application builder 162, although other types of and/or numbers of operations may be performed in other examples.

In one example, the functionalities of the agentic application builder 162 may be exposed as the developer GUI 122 rendered in a web page in a web browser accessible using the one or more developer devices 120(1)-120(n), such as a desktop or a laptop, by way of example. The one or more developers at the one or more developer devices 120(1)-120(n) may interact with user interface (UI) components, such as windows, tabs, widgets, or icons of the agentic application builder 162 in the developer GUI 122 rendered in the one or more developer devices 120(1)-120(n) to design, develop, configure, and/or deploy the one or more agentic applications 164(1)-164(n), the one or more AI agents 166(1)-166(n), or the one or more tools 168(1)-168(n). Additionally, the one or more developers at the one or more developer devices 120(1)-120(n) may interact with user interface (UI) components, such as windows, tabs, widgets, or icons of the agentic application builder 162 in the developer GUI 122 rendered in the one or more developer devices 120(1)-120(n) to host, create, import, configure, train, deploy, prompt, fine-tune, or optimize the one or more language models 172(1)-172(n), although any other types of and/or numbers of operations may be performed in other examples. The agentic application builder 162 described herein can be integrated with different application platforms, such as development platforms or development tools or components thereof already existing in the marketplace.

In this example, an agentic application is a software system designed to autonomously determine tasks from the user input, plan the execution of the tasks, make context-aware decisions, and route the tasks to the one or more AI agents 166(1)-166(n) for fulfillment without or with minimal user intervention. AI agents 166(1)-166(n) are specialized autonomous sub-systems within an agentic application that make use of one or more language models 172(1)-172(n) (e.g., large language models), and are responsible for executing specific tasks, interacting with users, collaborating with other AI agents in the agentic application, or accessing the one or more tools 168(1)-168(n) for fulfilling the tasks. For example, in an agentic application-“Bank Assist”, one or more AI agents 166(1)-166(n) may be configured and deployed to independently handle different banking related tasks. In this example, a first AI agent-“Loan Agent” may be configured to handle different loan related tasks, a second AI agent-“Cards Manager” may be configured to handle different cards related tasks, a third AI agent-“Transaction Manager” may be configured to handle fund transaction related tasks. Additionally, each of the one or more AI agents 166(1)-166(n) may be configured to access one or more of the tools 168(1)-168(n) specific to the tasks the one or more AI agents 166(1)-166(n) are required to fulfill. Thus, each of the one or more AI agents 166(1)-166(n) may have its own configuration comprising: a prompt, an LLM, a role, a description, one or more tools 168(1)-168(n), or a custom code to collaborate with other AI agents, which is further explained below in detail with reference to FIG. 2C. Further, the agentic application manages communication context and orchestrates communications and data flow between the one or more AI agents 166(1)-166(n) for fulfilling the tasks.

Referring back to FIG. 1B, the agentic AI platform 160 may host and manage the tools 168(1)-168(n) which refer to resources or services that the AI agents 166(1)-166(n) may leverage to interact with different computing environments or systems to perform specific tasks and make decisions to achieve desired goals and objectives. Although the tools 168(1)-168(n) are shown as hosted on the agentic AI platform 160 in FIG. 1B, the tools 168(1)-168(n) may be hosted externally to the agentic AI platform 160 such as, for example, on the external server 140. The one or more AI agents 166(1)-166(n) may leverage the one or more tools 168(1)-168(n) to access information, perform computations, query databases, generate and execute software code, control hardware, or the like. In one example, the one or more tools 168(1)-168(n) may include web-based search for dynamic information retrieval, APIs for data integration, simulation tools for predictive modeling, hardware interfaces for device control, or visualization tools for graphical output generation (e.g., images, videos, charts, etc.). The one or more developers at the one or more developer devices 120(1)-120(n) may define, configure, and integrate the one or more tools 168(1)-168(n) into the one or more agentic applications 164(1)-164(n) or the one or more AI agents 166(1)-166(n) using APIs, agent frameworks, or prompt-driven mechanisms via the GUI of the agentic application builder 162, although any other types and/or numbers of mechanisms may be used to define, configure, and integrate the one or more tools 168(1)-168(n). The integration of the one or more tools 168(1)-168(n) enhances the functionalities of the AI agents 166(1)-166(n) from simple reasoning, text generation, or conversational capabilities to performing complex workflows, making dynamic and real-time decisions, collaborating with other AI agents, or solving complex problems that require external knowledge or performing specific action-oriented tasks. Further, in one example, the one or more tools 168(1)-168(n) may be hosted and/or managed externally to the agentic AI platform 160 or the agentic AI server 150, such as, for example, on the external server 140 or a cloud computing environment (not shown).

Additionally, in one example, one or more of the tools 168(1)-168(n) may be shared and available for access by two or more of the AI agents 166(1)-166(n) corresponding to two or more of the agentic applications 164(1)-164(n). In another example, one or more of the tools 168(1)-168(n) may be specifically associated to and accessible by one or more of the AI agents 166(1)-166(n) corresponding to only one of the agentic applications 164(1)-164(n) and not accessible by other AI agents of other agentic applications.

Further, as illustrated in the example in FIG. 1B, the agentic AI platform 160 comprises the tool permissions manager 170, a framework that regulates and controls which of the one or more agentic applications 164(1)-164(n) or the one or more AI agents 166(1)-166(n) access and/or how they utilize the one or more tools 168(1)-168(n). The tool permissions manager 170 ensures that the one or more agentic applications 164(1)-164(n) or the one or more AI agents 166(1)-166(n) operate securely, efficiently, and in compliance with organizations predefined constraints by managing the permissions for each of the one or more tools 168(1)-168(n). The one or more developers at the one or more developer devices 120(1)-120(n) may configure each of the one or more tools 168(1)-168(n) by defining the usage scope of the tool, description of the tool, role of the tool, authentication and authorization requirements, and which of the one or more agentic applications 164(1)-164(n) or the one or more AI agents 166(1)-166(n) can access the tool, under what conditions or context, and to what extent.

Further, the tool permissions manager 170 includes auditing and logging capabilities to track and record usage of the one or more tools 168(1)-168(n) by the one or more agentic applications 164(1)-164(n) or the one or more AI agents 166(1)-166(n), for requirements such as, for example, monitoring for sensitive data, frequency of tool access requests, organizational policy or legal compliance checking, debugging, tool access pattern determination, or adjusting tool access permissions dynamically (e.g., based on the context of the tool access request), although the tool permissions manager 170 may have other types and/or numbers of capabilities in other examples. Thus, by managing and controlling tool interactions of the one or more agentic applications 164(1)-164(n) or the one or more AI agents 166(1)-166(n), the tool permissions manager 170 minimizes risks, prevents misuse, and ensures compliance with organizational policies or legal regulations.

Further, as illustrated in FIG. 1B, the agentic AI platform 160 may host and/or manage one or more language models 172(1)-172(n). The one or more language models 172(1)-172(n) may comprise, for example, LLMs that may be pre-trained general purpose LLMs (e.g., LLaMA 2, Claude, Cohere, Flan T5, BERT, GPT 3.5, GPT 4, . . . ) or fine-tuned LLMs, or small language models (e.g., Mistral 7B, DistilBERT, Phi-2, LLaMA 3, Gemma, . . . ) for an enterprise or one or more domains, although the one or more language models 172(1)-172(n) may comprise other types of language models in other examples. The agentic AI platform 160 may create, host, and/or manage the one or more language models 172(1)-172(n) based on the training provided by the one or more developers at the one or more developer devices 120(1)-120(n). The one or more language models 172(1)-172(n) may be integrated and/or accessed using APIs. In one example, the one or more language models 172(1)-172(n) may be hosted externally to the agentic AI server 150, such as, for example, on the external server 140 and managed remotely by the agentic AI server 150. In another example, the one or more language models 142(1)-142(n) may be hosted and managed externally to the agentic AI server 150, such as, for example, on the external server 140.

Upon deploying the one or more agentic applications 164(1)-164(n) or the one or more AI agents 166(1)-166(n), the users at the one or more user devices 110(1)-110(n) may communicate with the one or more agentic applications 164(1)-164(n) or the one or more AI agents 166(1)-166(n) to, for example, purchase products, raise tickets, access services provided by the enterprise, to know information about the products/services offered by the enterprise, or the like. Each of the one or more agentic applications 164(1)-164(n) or the one or more AI agents 166(1)-166(n) may be configured to fulfill one or more user related or system related tasks in one or more domains.

FIGS. 2A-2G are wireframes of graphical user interface (GUI) screens of the agentic application builder 162 illustrating exemplary ways to develop, configure, deploy, and simulate the one or more agentic applications 164(1)-164(n) and the one or more AI agents 166(1)-166(n) on the agentic AI server 150 illustrated in FIG. 1A. The wireframes of the GUI screens of the agentic application builder 162 illustrated in FIGS. 2A-2G are exemplary and it is to be understood that the GUI screens may comprise, in one example, a different layout with one or more additional windows, tabs, icons, buttons, menus or features, and in another example, the GUI screens may not comprise one or more of the windows, tabs, icons, buttons, menus or features illustrated in the wireframes of FIGS. 2A-2G.

FIG. 2A is a wireframe of the agentic application builder 162 illustrating an exemplary GUI 200 to create, deploy, and manage the one or more agentic applications 164(1)-164(n). As illustrated in FIG. 2A, the developers at the one or more developer devices 120(1)-120(n) may create the one or more agentic applications 164(1)-164(n) using an option “+New App 202”. Further, by using the option “+New App 202”, the developer at the developer device 120(1) may create an agentic application 164(1) by providing a name and a description to the agentic application 164(1). In this example, as illustrated in FIG. 2A, the agentic application 164(1) created is “HR Assist 204”.

FIG. 2B is a wireframe of the agentic application builder 162 illustrating an exemplary GUI 210 to create, configure, deploy, and manage the one or more AI agents 166(1)-166(n). In this example, upon selecting the created agentic application—“HR Assist 204”, the developers at the one or more developer devices 120(1)-120(n) may create and configure the one or more AI agents 166(1)-166(n) corresponding to the agentic application-“HR Assist 204” using an option “+New Agent 212” (as illustrated in FIG. 2C). In this example, as illustrated in FIG. 2B, the one or more AI agents 166(1)-166(n) created corresponding to the agentic application—“HR Assist 204” are “Employee Directory”, “Helper Agent”, and “Leave Agent”.

FIG. 2C is a wireframe of the agentic application builder 162 illustrating an exemplary GUI 220 to create and configure an AI agent 166(1). Upon clicking the option “+New Agent 212” (illustrated in FIG. 2B), the developer at the developer device 120(1) may create and configure an AI agent 166(1), as illustrated in FIG. 2C, by providing a name, a role, a description, a language model 172(1) for use by the AI agent 166(1), the one or more tools 168(1)-168(n) that the AI agent 166(1) can access, and a prompt for the language model 172(1). Although not illustrated in FIG. 2C, the AI agent 166(1) configuration may comprise other types and/or numbers of details in different formats in other examples.

While creating and configuring the AI agent 166(1), the developer at the developer device 120(1) may configure the one or more tools 168(1)-168(n) for the AI agent 166(1) to access for fulfilling the tasks. FIG. 2D is a wireframe of the agentic application builder 162 illustrating an exemplary GUI 230 for configuring a tool 168(1). Upon clicking the “+Add Tool” option illustrated in FIG. 2C, the developer at the developer device 120(1) is presented with the exemplary GUI 230 for configuring the tool 168(1), as illustrated in FIG. 2D. The tool 168(1) may be configured by providing details such as, for example, a tool name, a tool description, one or more tool parameters required to execute the tool, tool API, or a tool execution script. Although not illustrated in FIG. 2D, the tool configuration may comprise other types and/or numbers of details in different formats in other examples.

FIG. 2E is a wireframe of the agentic application builder 162 illustrating an exemplary GUI 240 for configuring orchestration capabilities for the agentic application, in this example, HR Assist 204. As illustrated in FIG. 2E, the developers at the one or more developer devices 120(1)-120(n) may select and configure one of the language models 172(1)-172(n) as a supervisor agent that can orchestrate communications related to the agentic application—HR Assist 204. The communications may comprise communication exchanges between: two or more of the AI agents 166(1)-166(n) of the agentic application-HR Assist 204; the one or more AI agents 166(1)-166(n) of the agentic application-HR Assist 204 and another one or more AI agents 166(1)-166(n) of other agentic applications; the one or more of the AI agents 166(1)-166(n) of the agentic application-HR Assist 204 and the one or more users at the one or more user devices 110(1)-110(n); or the one or more of the AI agents 166(1)-166(n) of the agentic application-HR Assist 204 and the one or more developers at the one or more developer devices 120(1)-120(n). The one or more developers at the one or more developer devices 120(1)-120(n), using the orchestration settings option 242 may define orchestration capabilities for the supervisor agent in the form of a textual prompt, which is described in detail further with reference to FIG. 2F.

FIG. 2F is a wireframe of the agentic application builder 162 illustrating an exemplary GUI 244 for defining the orchestration capabilities for the supervisor agent. Upon clicking on the orchestration settings option 242, the one or more developers at the one or more developer devices 120(1)-120(n) may be presented with the exemplary GUI 244. As illustrated in FIG. 2F, the one or more developer devices 120(1)-120(n) may provide the details such as, for example, roles and responsibilities of the supervisor agent, details of each of the AI agents 166(1)-166(n) of the agentic application (HR Assist 204, in this example), communication or task routing instructions, reasoning instructions, or one or more business rules, although the details may comprise any other types of and/or numbers of information in other examples. The details of each of the AI agents 166(1)-166(n) of the agentic application may comprise, for example, name, role(s), description, and tool(s) that the AI agent have access, although any other types of and/or numbers of details corresponding to each of the AI agents may be provided in other examples. For each of the one or more agentic applications 164(1)-164(n), all the related communications will be routed through the corresponding supervisor agent.

When the supervisor agent receives one or more communications, based on the information provided in the prompt, the supervisor agent may perform one or more operations, such as, for example, determining task(s)/action(s) to be performed, determining recipient(s) of the one or more communications, summarizing the one or more communications, routing the one or more communications to the recipient(s), collaborating with the one or more AI agents of the agentic application, generating one or more response(s) for the one or more communications, monitoring activity of the one or more AI agents of the agentic application, generating an explanation for the performed task(s)/action(s), tracking and logging the agentic application activity for auditing purposes, etc., although the supervisor agent may perform any other types of and/or numbers of operations in other examples. In one example, the supervisor agent of each of the one or more agentic applications 164(1)-164(n) acts as a mediator between one or more users (developers, or system components) and the one or more AI agents of the corresponding one of the agentic applications 164(1)-164(n). In another example, once a communication session is established between the one or more users (developers, or system components) and one of the AI agents (e.g., the AI agent 166(1)) of the agentic application 164(1), the supervisor agent corresponding to the agentic application 164(1) may offload the orchestration capabilities to the AI agent 166(1) and request the AI agent 166(1) to report back once the communication session ends.

FIG. 2G is a wireframe of the agentic application builder 162 illustrating an exemplary GUI 250 to simulate and test the flow of the created agentic application (HR Assist 204, in this example). As illustrated in FIG. 2G, the GUI 250 comprises sections 252, 254 and 256. The GUI section 252 provides the available menus options, such as, for example, the one or more AI agents 166(1)-166(n) configured, sharing and permission settings, API keys, tracing and audit logs, guardrails for using the agentic application, simulate flow, and other configurations, although the menu options may comprise other types and/or numbers of options in other examples. Further, as illustrated in FIG. 2G, upon the developer at the developer device 120(1) clicking on the menu option—“simulate flow”, the GUI section 254 is presented to the developer, where the developer may test the performance of the agentic application by providing inputs. The agentic application responds to the inputs using the configured one or more AI agents 166(1)-166(n). In this example, when the developer at the developer device 120(1) simulates the agentic application-HR Assist 204, based on the orchestration logic configured (as described above with reference to FIG. 2F), the agentic application—HR Assist 204 orchestrates the communications with the AI agents-Employee Directory, Helper Agent, and Leave Agent, to respond to the developer at the developer device 120(1).

Further, as illustrated in FIG. 2G, the GUI section 256 of the GUI 250 displays the hierarchy of components of the agentic application. In this example, the GUI section 256 displays the components of the agentic application-HR Assist 204 comprising the AI agents and the tools configured for the agentic application-HR Assist 204, in hierarchical form. The first level in the hierarchy from the top comprises the agentic application, the second level in the hierarchy from the top comprises the AI agents configured for the agentic application, and the last level in the hierarchy from the top comprises the one or more tools configured for the AI agents.

FIG. 2H is a wireframe of an exemplary GUI screen 260 of the tool permissions manager 170 that is presented to the developers at the one or more developer devices 120(1)-120(n) in the developer GUI 122. The tool permissions manager 170 is a critical component in an agentic AI system, responsible for controlling and managing which of the one or more AI agents 166(1)-166(n) can access the one or more tools 168(1)-168(n) and under what conditions. In one example, an independent tool permissions manager 170 may be configured for each of the one or more agentic applications 164(1)-164(n). For example, the tool permissions manager 170 configured for the agentic application 164(1) will be responsible for controlling and managing the access to the one or more tools 168(1)-168(n) by the one or more AI agents 166(1)-166(n) corresponding only to the agentic application 164(1). In another example, a single centralized tool permissions manager 170 may be configured across the one or more agentic applications 164(1)-164(n), which will be responsible for controlling and managing the access to the one or more tools 168(1)-168(n) by the one or more AI agents 166(1)-166(n) of the one or more agentic applications 164(1)-164(n).

As illustrated in FIG. 2H, the tool permissions manager 170 comprises tool permission settings which may be used by the developers at the one or more developer devices 120(1)-120(n) to configure the settings for each of the one or more tools 168(1)-168(n). For each tool, using the tool permission settings in the GUI screen 260, the developer at the one or more developer devices 120(1)-120(n) may configure one or more tool access types for one or more AI agent roles and one or more approvers for the one or more tool access types, as illustrated in FIG. 2H. The one or more tool access types may comprise types such as, for example, direct access, approval based access, delegation based access, etc., although the tool access types may comprise other types and/or numbers of methods in other examples. The one or more AI agent roles may comprise roles such as, for example, supervisor, worker, specialist, observer, etc., although there may be other types of and/or numbers of AI agent roles in other examples. The one or more approvers may comprise one or more human operators or one or more of the AI agents 166(1)-166(n) that are configured to function as approvers. Additionally, for each of the one or more tools 168(1)-168(n), for each of the one or more tool access types, the developers at the one or more developer devices 120(1)-120(n) may associate one or more AI agent roles. For example, as illustrated in FIG. 2H, the developer at the developer device 120(1) may define that the one or more AI agents 166(1)-166(n) configured with “specialist” role can directly access tool(1) and the one or more AI agents 166(1)-166(n) configured with “worker” role can access the tool(1) only upon seeking an approval from supervisor(1).

### Exemplary Definitions

Supervisor Agent: In an agentic application, a supervisor agent is an AI agent that is responsible for delegating and coordinating one or more tasks among one or more worker agents in the agentic application. The supervisor agent may also monitor the activities of the one or more worker agents after delegating the one or more tasks, to ensure alignment with goals and objectives, rules, and regulations, and intervene to reallocate resources or modify instructions. In one example, the supervisor agent may act as a standalone AI agent, perform one or more tasks, or execute one or more tools.

Worker Agent: In the agentic application, a worker agent is an AI agent that is configured to perform one or more specific tasks (e.g., generate text, retrieve data from data sources, execute tools, etc.). The worker agent may perform the one or more tasks based on a prompt provided and execute one or more tools to complete the assigned tasks.

Specialist Agent: In the agentic application, a specialist agent is an AI agent that is purpose-built and configured to perform one or more advanced or high-level domain-specific tasks. The specialist agent may be configured to access and execute one or more specialized or critical tools. For example, in a healthcare agentic application, the AI agent that analyzes medical reports and generates medical insights is a specialist agent that is purpose-built to deeply analyze medical reports.

Observer Agent: In the agentic application, an observer agent is an AI agent that continuously monitors the one or more AI agents of the agentic application for performance, anomalies, or deviations from expected behavior. The observer agent may be responsible for recording and managing activity logs, identifying anomalies, generating alerts, or assisting in debugging or audit processes.

Additionally, in one example, the one or more AI agents 166(1)-166(n) may be configured to switch between multiple roles depending on the context, which enables agentic AI systems to dynamically adapt to changing operational needs. For example, the AI agent 166(1) may be configured to act as a worker agent during a reasoning task and act as an observer agent when accessing the tool 168(1).

Further, as illustrated in FIG. 2H, the tool permissions manager 170 comprises a section for the developers at the one or more developer devices 120(1)-120(n) to define one or more business rules applicable to the one or more tools 168(1)-168(n) across the one or more agentic applications 164(1)-164(n) or the one or more AI agents 166(1)-166(n). Below are a few example business rules that may be defined in the business rules section of the tool permissions manager 170 associated with a bank agentic application-Bank Assist:
Rule (1): All the AI agents must seek an approval from a human operator before executing a fund transfer tool to process transactions exceeding $10,000.
Rule (2): For processing transactions exceeding $10,000, the AI agents can access the fund transfer tool only between 10:00 AM and 5:00 PM on business days.
Rule (3): Tools categorized as “worker” are not allowed to interact directly with other tools without explicit approval from a supervisor tool.
Rule (4): No tool is allowed to process more than 1,000 transactions per day without a human operator's approval.
Rule (5): No tool is allowed to run more than five concurrent tasks.
Rule (6): When any of the rules (1)-(5) are not obeyed by any of the AI agents, an alert should be generated and sent to a human operator.

With the tool permission settings and the one or more business rules configured, the tool permissions manager 170 ensures that the one or more AI agents 166(1)-166(n) operate within ethical, operational, and organizational boundaries, which in turn ensures accountability and prevents misuse of the one or more AI agents 166(1)-166(n) by malicious attackers, or unauthorized or inappropriate actions by one or more AI agents 166(1)-166(n).

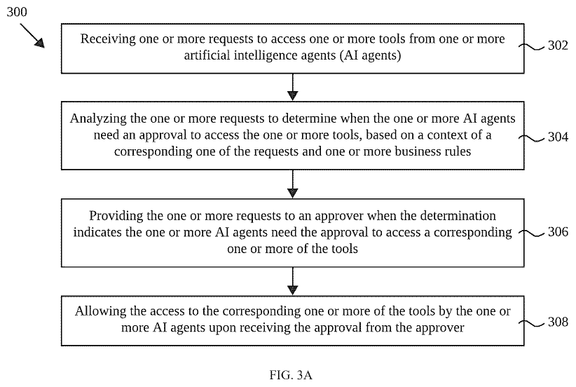

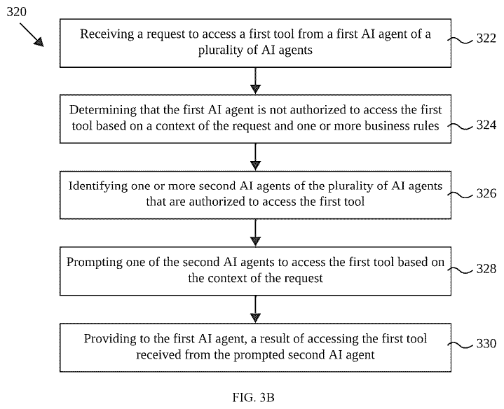

FIG. 3A is a flowchart of an exemplary method 300 for managing and controlling access to the one or more tools 168(1)-168(n) by the one or more AI agents 166(1)-166(n) at the agentic AI server 150 illustrated in FIG. 1A. The exemplary method 300 may be performed by the system components illustrated in the agentic AI server environment 100 of FIG. 1A. The agentic AI server 150 may interact with other components of the agentic AI server environment 100 to perform the steps of the exemplary method 300. In FIG. 3A, the ordering of steps of the method 300 is exemplary and any other ordering of the steps may be possible, not all the steps may be required, and in some implementations, some steps may be omitted, or other steps may be added.

At step 302, the agentic AI platform 160 receives one or more requests to access the one or more tools 168(1)-168(n) from the one or more AI agents 166(1)-166(n). In one example, the one or more AI agents 166(1)-166(n) are user facing AI agents that communicate with the users at the one or more user devices 110(1)-110(n), gets triggered by one or more user inputs or actions, and have access to the one or more tools 168(1)-168(n). In another example, the one or more AI agents 166(1)-166(n) are system facing AI agents that get triggered by one or more system generated inputs or events and have access to the one or more tools 168(1)-168(n). Additionally, in one example, the user facing AI agents may not have the access to the one or more tools 168(1)-168(n) that the system facing AI agents have access to and vice versa.

At step 304, the agentic AI platform 160 analyzes the received one or more requests to determine whether the one or more AI agents 166(1)-166(n) need an approval to access the one or more tools 168(1)-168(n), based on a context of a corresponding one of the requests and the one or more business rules. In one example, the agentic AI platform 160 makes use of the tool permission settings and the business rules defined in the tool permissions manager 170 to analyze the received one or more requests and determine the type of access defined for roles of the one or more AI agents 166(1)-166(n) for accessing the one or more tools 168(1)-168(n). Additionally, in this example, the agentic AI platform 160 determines a corresponding approver that needs to approve the tool access request, when the determination indicates that the AI agent 166(1) needs the approval to access the tool 168(1).

The context of a request may comprise one or more of: details of a corresponding one of the AI agents 166(1)-166(n) from which the request is received, interaction history, current task, and one or more parameters required to access the corresponding one or more of the tools 168(1)-168(n). The details of the AI agent 166(1) may comprise: an agent identifier (e.g., name, which may be in the form of text, numbers, alphanumeric, or the like), role (e.g., supervisor, worker, specialist, observer, etc.), operating domain (e.g., banking), one or more tasks that the AI agent 166(1) is configured to handle (e.g., checking balance), and timestamp of the request. Additionally, the current task may refer to the task that is currently being executed or performed by the AI agent 166(1). The one or more parameters required to access a tool 168(1) may refer to the parameters that are necessary for executing the tool 168(1). For example, in the case of a tool configured for applying leaves, the parameters that are necessary for applying a leave may include: employee ID, leave type, leave start date, and leave end date. Additionally, access to the tool 168(1) may be allowed only when the one or more parameters that are necessary for executing the tool 168(1) are available in the received tool access request.

The interaction history, in one example, may refer to the recorded communication exchanges between the AI agent 166(1) and the user at the one or more user devices 110(1)-110(n), which may include one or more of: user input(s), response(s) of the AI agent 166(1), task(s)/action(s) performed by the AI agent 166(1), or the like. In another example, the interaction history may refer to the recorded communication exchanges between the AI agent 166(1) and another AI agent 166(n), which may include one or more of: the message(s)/command(s)/data exchanged between the AI agent 166(1) and the AI agent 166(n), task(s)/action(s) performed by the AI agent 166(1) and the AI agent 166(n), decision(s) made by the AI agent 166(1) and the AI agent 166(n), or the like.

Referring back to FIG. 3A, at step 306, the agentic AI platform 160 provides the one or more requests to an approver when the determination (at step 304) indicates that the one or more AI agents 166(1)-166(n) need the approval to access a corresponding one or more of the tools 168(1)-168(n). Upon determining the approver that needs to approve the one or more requests from the one or more AI agents 166(1)-166(n) (at step 304), the agentic AI platform 160 provides the one or more requests along with the corresponding context and frequency of the request, to the approver for review and approval. In one example, the approver may be an enterprise user (e.g., a developer, system administrator, product owner, etc.) or one of the AI agents 166(1)-166(n) that are configured with an approver role. In this example, when the approver is one of the AI agents 166(1)-166(n), the agentic AI platform 160 prompts the approver with the details corresponding to the one or more requests, as described above at step 306, for review and approval. Additionally, in this example, when the approver is the enterprise user, the agentic AI platform 160 may provide the details corresponding to the one or more requests as a notification to the enterprise user at one of the developer devices 120(1)-120(n), as described above at step 306, for review and approval. Further, the approver may review the provided details corresponding to the one or more requests and either approve or reject the one or more requests.

Subsequently, at step 308, the agentic AI platform 160 allows the access to the corresponding one or more of the tools 168(1)-168(n) by the one or more AI agents 166(1)-166(n) upon receiving the approval from the approver. Additionally, in one example, the agentic AI platform 160 may track and store in the memory 154 tool access request logs comprising: the frequency of the one or more requests to access the one or more tools 168(1)-168(n) from the one or more AI agents 166(1)-166(n); a timestamp of each of the one or more requests; and the number of approvals or rejections for each of the one or more requests from the one or more AI agents 166(1)-166(n).

Additionally, the agentic AI platform 160 may analyze the tool access request logs to determine whether any AI agent (e.g., AI agent 166(1)) has previously been granted access to any particular tool of the one or more tools 168(1)-168(n) a predefined number of times (e.g., 500, 750, 1000, etc.) within a predefined threshold time period (e.g., last 30 days, 60 days, quarter, etc.). Upon identifying that the AI agent 166(1) has previously been granted access to one particular tool, e.g., tool 168(1) for the predefined number of times within the predefined threshold time period, the agentic AI platform 160 may auto-approve one or more future requests from the AI agent 166(1) to access the corresponding tool 168(1), without requiring explicit approval from the approver. This method of determining tool access patterns and auto approving the one or more future requests to access the one or more tools 168(1)-168(n) from the one or more AI agents 166(1)-166(n) may enhance the efficiency of the agentic AI system by reducing redundant approval requests and minimizing delays in tool access. Additionally, by analyzing the tool access request logs, the agentic AI platform 160 may develop trust for the one or more AI agents 166(1)-166(n) for future tool access requests.

Further, the agentic AI platform 160 may also track and store the logs for tool access requests that are auto approved. The agentic AI platform 160 may analyze these logs, develop further trust, and generate a recommendation for the one or more enterprise users at the one or more developer devices 120(1)-120(n) to change a role of the AI agent or adding an additional role to the configuration of the AI agent (e.g., AI agent 166(1)), when the AI agent 166(1) has been auto approved to access a particular tool, e.g., tool 168(1) a second predefined threshold number of times within a second predefined threshold time period. The recommendation may comprise information such as, for example, the details of the AI agent for which the recommendation is made, summary of the logs analysis based on which the recommendation is made, details of the tool(s) for whose access the AI agent has gained the auto approval, and a role that is being recommended for the AI agent and why, although the recommendation may comprise any other types and/or numbers of details. The role that may be recommended for the AI agent may comprise, for example, an approver, a supervisor, a specialist, or the like. The one or more enterprise users at the one or more developer devices 120(1)-120(n) may review the recommendation and modify the configuration of the AI agent 166(1) accordingly. In another example, based on the analysis described above, the agentic AI platform 160 may automatically modify the configuration of the AI agent 166(1) with a new role and a new prompt, and notify the one or more enterprise users at the one or more developer devices 120(1)-120(n) to review the modifications before deployment. In another example, the generated recommendation and corresponding logs may be provided by the agentic AI platform 160 to one of the AI agents 166(1)-166(n) that is configured as a “review specialist”, for reviewing the recommendation before automatically modifying the configuration of the AI agent 166(1), which may reject or approve the recommendation, or generate new recommendations.

For example, in the agentic AI system comprising a tool 168(1) and four AI agents 166(1)-166(4), the AI agent 166(1) may be configured with a supervisor role and the other three AI agents 166(2)-166(4) are configured with worker roles. In this example, the three worker AI agents 166(2)-166(4) may be initially configured to access the tool 168(1) only upon getting an approval from the supervisor AI agent 166(1). Further, in this example, based on the logs analysis described above, the worker AI agent 166(2) may have won the trust of the agentic AI platform 160 and has gained the auto approval for accessing the tool 168(1). Additionally, the worker AI agent 166(2) may be recommended for a role change to an approver. Once, the worker AI agent 166(2) role is changed to approver, any future requests to access the tool 168(1) from the other two worker AI agents 166(3)-166(4) may be now routed to the AI agent 166(2) for approval instead of being sent to the supervisor AI agent 166(1), which reduces the workload on the supervisor AI agent 166(1) and allowing it to handle other important tasks. This method allows for better resource allocation, reduced delays in tool access, and efficient load balancing in the agentic AI system.

FIG. 3B is a flowchart of another exemplary method 320 for managing and controlling access to the one or more tools 168(1)-168(n) by the one or more AI agents 166(1)-166(n) at the agentic AI server 150 illustrated in FIG. 1A. The exemplary method 320 may be performed by the system components illustrated in the agentic AI server environment 100 of FIG. 1A. The agentic AI server 150 may interact with other components of the agentic AI server environment 100 to perform the steps of the exemplary method 320. In FIG. 3B, the ordering of steps of the method 320 is exemplary and any other ordering of the steps may be possible, not all the steps may be required, and in some implementations, some steps may be omitted, or other steps may be added.

At step 322, the agentic AI platform 160 receives a request to access one of the tools 168(1)-168(n), hereinafter referred to as a “first tool 168(1)”, from one of the AI agents 166(1)-166(n), hereinafter referred to as a “first AI agent 166(1)”.

At step 324, the agentic AI platform 160 determines that the first AI agent 166(1) is not authorized to or does not have access to the first tool 168(1) based on the context of the request and the one or more business rules. The context of the request may comprise one or more of: details of the first AI agent 166(1) from which the request is received, interaction history, current task, and one or more parameters required to access the first tool 168(1). The details of the first AI agent 166(1) may comprise: an agent identifier (e.g., name, which may be in the form of text, numbers, alphanumeric, or the like), role (e.g., supervisor, worker, specialist, observer, etc.), operating domain (e.g., banking), one or more tasks that the first AI agent 166(1) is configured to handle (e.g., checking balance), and timestamp of the request.

At step 326, the agentic AI platform 160 identifies one or more second AI agents of the one or more AI agents 166(1)-166(n) that have access to or are authorized to access the first tool 168(1) using the tool permission settings defined in the tool permissions manager 170.

At step 328, the agentic AI platform 160 prompts one of the identified second AI agents, hereinafter known as the “second AI agent 166(5)” to access the first tool 168(1) based on the context of the request. In one example, one of the AI agents 166(1)-166(n) that has access to the first tool 168(1) and whose output can be consumed by the first AI agent 166(1) (e.g., determined based on the business rules) is identified as the second AI agent. Additionally, the second AI agent 166(5) may be prompted by the agentic AI platform 160 only when the request received for the first AI agent 166(1) to access the first tool 168(1) comprises all the parameters that are required for executing the first tool 168(1). When the request to access the first tool 168(1) does not comprise all the required parameters, the agentic AI platform 160 prompts the first AI agent 166(1) to send a new access request with all the parameters that are required for executing the first tool 168(1).

Subsequently, at step 330, the agentic AI platform 160 provides the first AI agent 166(1) a result of accessing the first tool 168(1) received from the second AI agent 166(5). In one example, upon prompting, the second AI agent 166(5) access or executes the first tool 168(1) based on the context of the request provided and outputs the result of the execution to the agentic AI platform 160, which in turn provides the result to the first AI agent 166(1). In another example, the second AI agent 166(5) may provide the result of executing the first tool 168(1) directly to the first AI agent 166(1).

Additionally, the agentic AI platform 160 may also track and store the logs for tool access requests made by the one or more AI agents 166(1)-166(n). In this example, the agentic AI platform 160 may analyze the tool access request logs of the first AI agent 166(1), develop trust for the first AI agent 166(1), and generate a recommendation for the one or more enterprise users at the one or more developer devices 120(1)-120(n) to provide access to the first tool 168(1) for the first AI agent 166(1), when the first AI agent 166(1) does not have the access to the first tool 168(1), but made a predefined number of requests (e.g., 750, 1000, 1500, etc.) to access the first tool 168(1) within a predefined threshold time period (e.g., last 30 days, 60 days, quarter, etc.). The recommendation may comprise information such as, for example, the details of the first AI agent 166(1) for which the recommendation is being made, summary of the logs analysis and a reason based on which the recommendation is being made, and details of the first tool 168(1) for whose access the recommendation is being made, although the recommendation may comprise any other types and/or numbers of details. The one or more enterprise users at the one or more developer devices 120(1)-120(n) may review the recommendation and modify the configuration of the first AI agent 166(1) accordingly. In another example, based on the analysis described above, the agentic AI platform 160 may automatically add access to the first tool 168(1) in the tools section of the first AI agent 166(1) configuration.

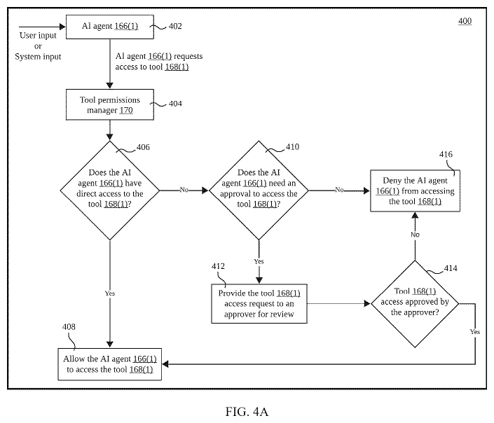

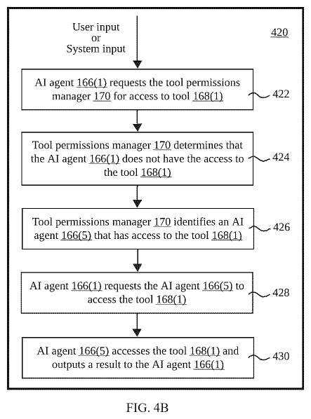

FIG. 4A is an exemplary flow diagram 400 of method 300 illustrated in FIG. 3A for managing and controlling access to the one or more tools 168(1)-168(n) by the one or more AI agents 166(1)-166(n) at the agentic AI server 150 shown in FIG. 1A. Further, it may be understood that the steps illustrated in FIG. 4A do not have to take place in the sequence illustrated in the exemplary flow diagram 400. Furthermore, it may be understood that one or more components and the one or more steps illustrated in FIG. 4A may not be needed for managing and controlling tool access. Although not illustrated in FIG. 4A, other components of the agentic AI server environment 100 may also be used to implement the exemplary method disclosed herein.

As illustrated at step 402, the AI agent 166(1) may receive a user input from the one or more user devices 110(1)-110(n) or a system input from one or more components of the agentic AI server environment 100. In one example, when the AI agent 166(1) is a user facing AI agent, then the AI agent 166(1) gets triggered by the user input. For example, if the AI agent 166(1) is a “check balance agent” and is user facing, then the check balance agent may be triggered by one or more user inputs such as—“Show me my balance”, “What is my account balance?”, etc. In another example, when the AI agent 166(1) is a system facing AI agent, then the AI agent 166(1) gets triggered by the system input. For example, if the AI agent 166(1) is a “loan processing agent” and is system facing, then the loan processing agent may be triggered when a new loan application is received by a banking system.

Further, at step 402, the AI agent 166(1) may analyze the received input, determine one or more tasks to be fulfilled from the input, and determine that the tool 168(1) needs to be accessed to fulfill the one or more tasks. Further, the AI agent 166(1) may request the tool permissions manager 170 to access the tool 168(1).

At steps 404 and 406, based on the context of the request, the tool permissions manager 170 determines whether the AI agent 166(1) is allowed direct access the tool 168(1). At step 408, the AI agent 166(1) may be directly allowed to access the tool 168(1), when it is determined (at step 406) that the AI agent 166(1) has direct access to the tool 168(1).

Further, as illustrated in FIG. 4A, at step 410, the tool permissions manager 170 determines whether the AI agent 166(1) need any explicit approval to access the tool 168(1). At step 412, the request to access the tool 168(1) received from the AI agent 166(1) is provided to an approver for review and approval, when it is determined (at step 410) that the AI agent 166(1) requires an explicit approval from the approver to access the tool 168(1). Further, at step 414, when the approver approves the AI agent 166(1) to access the tool 168(1), the AI agent 166(1) is allowed to access the tool 168(1). Furthermore, when at step 410 it is determined that the AI agent 166(1) is not allowed to access the tool 168(1) or when at step 414 the approver rejects the tool access request, the AI agent 166(1) is denied access to the tool 168(1), as illustrated at step 416 of FIG. 4A.

FIG. 4B is an exemplary flow diagram 420 of method 320 illustrated in FIG. 3B for managing and controlling access to the one or more tools 168(1)-168(n) by the one or more AI agents 166(1)-166(n) at the agentic AI server 150 shown in FIG. 1A. Further, it may be understood that the steps illustrated in FIG. 4B do not have to take place in the sequence illustrated in the exemplary flow diagram 420. Furthermore, it may be understood that one or more components and the one or more steps illustrated in FIG. 4B may not be needed for managing and controlling tool access. Although not illustrated in FIG. 4B, other components of the agentic AI server environment 100 may also be used to implement the exemplary method disclosed herein.

As illustrated at step 422, the AI agent 166(1) may receive the user input from the one or more user devices 110(1)-110(n) or the system input from one or more components of the agentic AI server environment 100. Further, at step 422, the AI agent 166(1) may analyze the received input, determine one or more tasks to be fulfilled from the input, and determine that the tool 168(1) needs to be accessed to fulfill the one or more tasks. Further, the AI agent 166(1) may request the tool permissions manager 170 to access the tool 168(1).

At step 424, the tool permissions manager 170 may determine that the AI agent 166(1) does not have the access to the tool 168(1). At step 426, the tool permissions manager 170 may identify another AI agent, for example, AI agent 166(5), that has access to tool 168(1) and informs the AI agent 166(1) about the AI agent 166(5).

At step 428, the AI agent 166(1) may provide the required context and request the AI agent 166(5) to access the tool 168(1). In one example, instead of the AI agent 166(1) requesting the AI agent 166(5) to access the tool 168(1), the tool permissions manager 170 may forward the tool access request the AI agent 166(5). Subsequently, at step 430, the AI agent 166(5) may output a result of executing the tool 168(1) to the AI agent 166(1).

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
receiving, by an agentic artificial intelligence platform (agentic AI platform), one or more requests to access one or more tools from one or more artificial intelligence agents (AI agents);
analyzing, by the agentic AI platform, the one or more requests to determine when the one or more AI agents need an approval to access the one or more tools, based on a context of a corresponding one of the requests and one or more business rules;
providing, by the agentic AI platform, the one or more requests to an approver when the determination indicates the one or more AI agents need the approval to access a corresponding one or more of the tools; and
allowing, by the agentic AI platform, the access to the corresponding one or more of the tools by the one or more AI agents upon receiving the approval from the approver.

2. The method of claim 1, further comprising: auto-approving one of the AI agents to access the corresponding one or more of the tools for one or more successive requests received from the one of the AI agents, when a predefined number of the requests previously received from the one of the AI agents for the corresponding one or more of the tools have been approved.

3. The method of claim 1, wherein the context of the request comprises: details of a corresponding one of the AI agents from which the request is received, interaction history, current task, and one or more parameters required to access the corresponding one or more of the tools.

4. The method of claim 3, wherein the details of the AI agent comprise: an agent identifier, role, operating domain, one or more tasks that the AI agent is configured to handle, and a timestamp of the request.

5. The method of claim 1, wherein the providing the one or more requests to the approver comprises: the context of the request, and a frequency of the request from the AI agent to access the corresponding tool.

6. The method of claim 1, wherein the approver is an enterprise user or one of the AI agents that are configured with an approver role.

7. An agentic artificial intelligence server (agentic AI server) comprising:
one or more processors; and
a memory coupled to the one or more processors which are configured to execute programmed instructions stored in the memory to:
receive one or more requests to access one or more tools from one or more artificial intelligence agents (AI agents);
analyze the one or more requests to determine when the one or more AI agents need an approval to access the one or more tools, based on a context of a corresponding one of the requests and one or more business rules;
provide the one or more requests to an approver when the determination indicates the one or more AI agents need the approval to access a corresponding one or more of the tools; and
allow the access to the corresponding one or more of the tools by the one or more AI agents upon receiving the approval from the approver.

8. The agentic AI server of claim 7, the one or more processors are further configured to execute programmed instructions stored in the memory to:
auto-approve one of the AI agents to access the corresponding one or more of the tools for one or more successive requests received from the one of the AI agents, when a predefined number of the requests previously received from the one of the AI agents for the corresponding one or more of the tools have been approved.

9. The agentic AI server of claim 7, wherein the context of the request comprises:
details of a corresponding one of the AI agents from which the request is received, interaction history, current task, and one or more parameters required to access the corresponding one or more of the tools.

10. The agentic AI server of claim 9, wherein the details of the AI agent comprise: an agent identifier, role, operating domain, one or more tasks that the AI agent is configured to handle, and a timestamp of the request.

11. The agentic AI server of claim 7, wherein the one or more requests provided to the approver comprises: the context of the request, and a frequency of the request from the AI agent to access the corresponding tool.

12. The agentic AI server of claim 7, wherein the approver is an enterprise user or one of the AI agents that are configured with an approver role.

13. A non-transitory computer-readable medium storing instructions which when executed by one or more processors, causes the one or more processors to:
receive one or more requests to access one or more tools from one or more artificial intelligence agents (AI agents);
analyze the one or more requests to determine when the one or more AI agents need an approval to access the one or more tools, based on a context of a corresponding one of the requests and one or more business rules;
provide the one or more requests to an approver when the determination indicates the one or more AI agents need the approval to access a corresponding one or more of the tools; and
allow the access to the corresponding one or more of the tools by the one or more AI agents upon receiving the approval from the approver.

14. The non-transitory computer-readable medium of 13, further comprising instructions which when executed by the one or more processors, causes the one or more processors to:
auto-approve one of the AI agents to access the corresponding one or more of the tools for one or more successive requests received from the one of the AI agents, when a predefined number of the requests previously received from the one of the AI agents for the corresponding one or more of the tools have been approved.

15. The non-transitory computer-readable medium of 13, wherein the context of the request comprises: details of a corresponding one of the AI agents from which the request is received, interaction history, current task, and one or more parameters required to access the corresponding one or more of the tools.

16. The non-transitory computer-readable medium of 15, wherein the details of the AI agent comprise: an agent identifier, role, operating domain, one or more tasks that the AI agent is configured to handle, and a timestamp of the request.

17. The non-transitory computer-readable medium of 13, wherein the one or more requests provided to the approver comprises: the context of the request, and a frequency of the request from the AI agent to access the corresponding tool.

18. The non-transitory computer-readable medium of 13, wherein the approver is an enterprise user or one of the AI agents that are configured with an approver role.

19. A method comprising:
receiving, by an agentic artificial intelligence platform (agentic AI platform), a request to access a first tool from a first artificial intelligence agent (AI agent) of a plurality of AI agents;
determining, by the agentic AI platform, that the first AI agent is not authorized to access the first tool based on a context of the request and one or more business rules;
identifying, by the agentic AI platform, one or more second AI agents of the plurality of AI agents that are authorized to access the first tool;
prompting, by the agentic AI platform, one of the second AI agents to access the first tool based on the context of the request; and
providing, by the agentic AI platform, to the first AI agent, a result of accessing the first tool received from the prompted second AI agent.

20. The method of claim 19, further comprising:
providing, to an enterprise user device, a recommendation to provide access to the first tool for the first AI agent, when the first AI agent does not have the access to the first tool and made a predefined number of requests to access the first tool within a predefined threshold time period.

21. The method of claim 19, wherein the context of the request comprises: details of the first AI agent, interaction history, current task, and one or more parameters required to access the first tool.

22. The method of claim 21, wherein the details of the first AI agent comprise: an agent identifier, operating domain, role, one or more tasks that the first AI agent is configured to handle, and timestamp of the request.

23. The method of claim 19, further comprising:
prior to the prompting the second AI agent, verifying, by the agentic AI platform, the request from the first AI agent for the inclusion of one or more parameters required to access the first tool.

24. The method of claim 23, wherein, when the one or more parameters are not included in the request, the first AI agent is prompted, by the agentic AI platform, to resend the request by including the one or more parameters required to access the first tool.
